(19) United States
(12) Patent Application Publication
(10) Pub. No.: US 2025/0223194 A1
(43) Pub. Date: Jul. 10, 2025

(54) TERNARY PRECURSOR WITH HIGH TAP DENSITY AND METHOD FOR PREPARING SAME

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/851,113

(22) PCT Filed: Feb. 8, 2023
(86) PCT No.: PCT/CN2023/074950

§ 371 Date: Sep. 26, 2024

(30) Foreign Application Priority Data
Apr. 24, 2022 (CN) 202210445604.1

(51) Int. Cl. C01G 53/84; C01B 33/113; H01M 4/525

(52) U.S. Cl. CPC C01G 53/84; C01B 33/113; C01P 2002/50; C01P 2004/03; C01P 2004/50; C01P 2004/61; C01P 2006/11; C01P 2006/40; H01M 4/525

(57) ABSTRACT

Disclosed herein are a ternary precursor with a high tap density and a method for preparing same. The method comprises the following steps: (1) adding a silicon dioxide emulsion into an alkaline substrate solution to give a mixed solution; (2) adding a mixed nickel-cobalt-manganese salt solution, a precipitant, a complexing agent, and a surfactant; (3) conducting solid-liquid separation to give a solid material, and drying and crushing to give a crushed material; (4) mixing the crushed material with the alkaline substrate solution and the surfactant; (5) repeating step (2); and (6) conducting solid-liquid separation to give a solid material, and washing and drying the solid material to give the ternary precursor with a high tap density. The precursor particle prepared according to the method has a higher tap density, and can provide excellent cycle performance for the positive electrode material.

### TECHNICAL FIELD

The present disclosure belongs to the technical field of lithium battery cathode materials, and particularly relates to a ternary precursor with high tap density and a preparation method therefor.

### BACKGROUND

Since the commercialization of lithium-ion batteries (LIBs), the application field of LIBs has gradually expanded from the initial 3C electronics field to the traction field, and accordingly, there are higher and higher requirements for the safety, energy density, and service life of LIBs. In a manufacturing process of a battery, a cathode material, as one of the most important parts of the battery, determines the performance and application field of the battery to some extent.

Ternary cathode materials have gradually become mainstream products on the market due to their advantage of high energy density. Industrially, the co-precipitation method is commonly used to first prepare a nickel-cobalt-manganese hydroxide precursor, and then the nickel-cobalt-manganese hydroxide precursor and a lithium source are mixed and sintered to prepare a cathode material. A ternary precursor is a main raw material for preparing a ternary cathode material, and thus the structure and performance of the ternary precursor directly determine the structure and performance of the ternary cathode material. It is well known that a cathode material can inherit the morphological and structural characteristics of a precursor thereof, various performances of a cathode material largely depend on the physical and chemical properties of a precursor thereof, and a technical content of precursor preparation accounts for 60% or higher of a technical content of the entire ternary material. Therefore, the structure and preparation process of a precursor have a crucial influence on the performance of a cathode material.

At present, the co-precipitation method is a mainstream preparation method for a precursor material, which can accurately control a content of each component and achieve the atomic-level mixing of components. In the method, the synthesis process parameters such as solution concentration, pH, reaction time, reaction temperature, and stirring speed can be adjusted to prepare materials with different particle sizes, morphologies, densities, and crystallinity degrees.

The co-precipitation method is currently the most widely used, and its industrialization is relatively mature. However, when the existing co-precipitation method is used to prepare a precursor material, due to the rapid formation and agglomeration of primary particles and the higher precipitation rate during co-precipitation, the primary particles generally have a smaller particle size and a lower crystallinity degree, and are not compact enough, such that a precursor has a lower overall density and a lower tap density, which will affect the cycling performance of a cathode material subsequently prepared by sintering.

### SUMMARY

The present disclosure is intended to solve at least one of the technical problems existing in the prior art. In view of this, the present disclosure provides a ternary precursor with high tap density and a preparation method therefor. The preparation method can lead to coarse and compact precursor particles, and the precursor particles have a higher tap density, which can improve the cycling performance of a cathode material subsequently prepared by sintering the particles.

The above technical objective of the present disclosure is achieved by the following technical solutions.

A preparation method for a ternary precursor with high tap density is provided, including the following steps:
(1) adding a silica emulsion to an alkaline base solution under stirring to obtain a mixed liquid;
(2) adding a solution of mixed salts of metal ions of nickel, cobalt, and manganese, a precipitating agent, a complexing agent, and a surfactant to the mixed liquid in step (1) to allow a reaction until D50 of a material in the mixed liquid reaches 1.0 μm to 3.0 μm;
(3) separating the material in step (2) by solid-liquid separation (SLS) to obtain a solid material, and drying and crushing the solid material to obtain a crushed material;
(4) mixing the crushed material obtained in step (3) with the alkaline base solution and the surfactant to obtain a mixture;
(5) adding the solution of mixed salts of metal ions of nickel, cobalt, and manganese, the precipitating agent, the complexing agent, and the surfactant to the mixture in step (4) to allow a reaction until D50 of a material in the mixture reaches 5.0 μm to 15.0 μm; and
(6) separating the material in step (5) by SLS to obtain a solid material, and washing and drying the solid material to obtain the ternary precursor with high tap density.

Preferably, the alkaline base solution may be a mixed solution of sodium hydroxide and aqueous ammonia; and the alkaline base solution may have a pH of 10.0 to 11.0 and an ammonia concentration of 2.0 g/L to 10.0 g/L.

Preferably, in step (1), the mixed liquid may have a silica mass concentration of 1% to 3% and a silica particle size of 1 nm to 100 nm.

Preferably, a total concentration of metal ions of nickel, cobalt, and manganese in the solution of mixed salts of metal ions of nickel, cobalt, and manganese may be 1.0 mol/L to 2.5 mol/L.

Preferably, the precipitating agent may be a sodium hydroxide solution with a concentration of 4.0 mol/L to 8.0 mol/L.

Preferably, the complexing agent may be aqueous ammonia with a concentration of 6.0 mol/L to 12.0 mol/L.

Preferably, the surfactant may be at least one of an alkylbenzene sulfonate (ABS) aqueous solution, an alkylnaphthalene sulfonate (ANS) aqueous solution, and an alkylsulfonate aqueous solution; and the surfactant may have a concentration of 0.1 mol/L to 2 mol/L.

Preferably, in step (1), the silica emulsion may be subjected to ultrasonic dispersion for 20 min to 30 min before being added to the alkaline base solution.

Preferably, the crushed material obtained in step (3) may have a particle size D50 of 100 nm to 500 nm.

Preferably, in steps (2) and (5), the solution of mixed salts of metal ions of nickel, cobalt, and manganese, the precipitating agent, the complexing agent, and the surfactant may be added concurrently, during which a pH of the mixed liquid in step (2) and the mixture in step (5) is controlled at 10.0 to 11.0, an ammonia concentration is controlled at 2.0 g/L to 10.0 g/L, and a flow rate of the surfactant is controlled to be 10% to 100% of a flow rate of the mixed salt solution.

Preferably, the reactions in steps (2) and (5) may be conducted at 45° C. to 65° C.

Preferably, a preparation method for a ternary precursor with high tap density may be provided, including the following steps:
(1) according to a molar ratio Ni:Co:Mn=1-a-b:a:b, using soluble salts of nickel, cobalt, and manganese as raw materials to prepare a mixed salt solution in which a total concentration of metal ions of nickel, cobalt, and manganese is 1.0 mol/L to 2.5 mol/L;
(2) preparing a sodium hydroxide solution with a concentration of 4.0 mol/L to 8.0 mol/L as a precipitating agent;
(3) preparing aqueous ammonia with a concentration of 6.0 mol/L to 12.0 mol/L as a complexing agent;
(4) preparing a surfactant aqueous solution with a concentration of 0.1 mol/L to 2 mol/L, where a surfactant in the surfactant aqueous solution is ABS, ANS, or alkylsulfonate;
(5) adding an alkaline base solution to a reactor until a bottom stirring paddle is immersed, and starting stirring, where the alkaline base solution is a mixed solution of sodium hydroxide and aqueous ammonia, and the alkaline base solution has a pH of 10.0 to 11.0 and an ammonia concentration of 2.0 g/L to 10.0 g/L;
(6) subjecting a silica emulsion to ultrasonic dispersion for 20 min to 30 min before adding it to the alkaline base solution, where a resulting alkaline base solution has a silica mass concentration of 1% to 3% and a silica particle size of 1 nm to 100 nm;
(7) concurrently feeding the mixed salt solution prepared in step (1), the sodium hydroxide solution prepared in step (2), the aqueous ammonia prepared in step (3), and the surfactant aqueous solution prepared in step (4) into the reactor to allow a reaction at a temperature of 45° C. to 65° C., a pH of 10.0 to 11.0, and an ammonia concentration of 2.0 g/L to 10.0 g/L, where a flow rate of the surfactant aqueous solution is controlled to be 10% to 100% of a flow rate of the mixed salt solution;
(8) when it is detected that D50 of a material in the reactor reaches 1.0 μm to 3.0 μm, stopping the feeding;
(9) separating the material in the reactor by SLS to obtain a solid material, drying the solid material, and crushing a dried solid material with an air-jet crusher to obtain a crushed material with a particle size D50 of 100 nm to 500 nm;
(10) adding the crushed material to a reactor, adding a base solution until a bottom stirring paddle of the reactor is immersed, and starting stirring, where the base solution is a mixed solution of sodium hydroxide, aqueous ammonia, and the surfactant, and the base solution has a pH of 10.0 to 11.0, an ammonia concentration of 2.0 g/L to 10.0 g/L, and a surfactant concentration of 2 mol/L;
(11) concurrently feeding the mixed salt solution prepared in step (1), the sodium hydroxide solution prepared in step (2), the aqueous ammonia prepared in step (3), and the surfactant aqueous solution prepared in step (4) into the reactor to allow a reaction at a temperature of 45° C. to 65° C., a pH of 10.0 to 11.0, and an ammonia concentration of 2.0 g/L to 10.0 g/L, where a flow rate of the surfactant aqueous solution is controlled to be 10% to 100% of a flow rate of the mixed salt solution;
(12) when it is detected that D50 of a material in the reactor reaches 5.0 μm to 15.0 μm, stopping the feeding;
(13) separating the material in the reactor by SLS to obtain a solid material; and
(14) washing, drying, sieving, and demagnetizing the solid material to obtain the ternary precursor with high tap density.

A ternary precursor with high tap density prepared by the preparation method described above is provided.

Preferably, the ternary precursor with high tap density may have a general chemical formula of Ni_{1-a-b}Co₂Mn_{b}(OH)₂·xSiO₂, where 0<a<1 and 0<b<1; and the ternary precursor with high tap density may be composed of secondary particles agglomerated by primary particles, where the primary particles are in a shape of blocky cubes and have a particle size of 0.1 μm to 5.0 μm (1.0 μm to 3.0 μm in the preparation method), and the secondary particles obtained by agglomeration have a particle size of 5.0 μm to 15.0 μm.

The present disclosure has the following beneficial effects.

In the present disclosure, a silica emulsion is added to an alkaline base solution, and a surfactant is used to conduct a co-precipitation reaction. Silica particles play the role of steric hindrance, and can effectively isolate primary particles generated by the reaction and slow down the agglomeration of the primary particles, such that the primary particles gradually grow. The surfactant plays a role of growth induction, and can promote the growth of primary particle crystals, which allows the primary particles to grow slowly with prominent crystallinity under the synergistic control of low pH. In addition, the effective isolation of silica makes the agglomeration of the material not compact enough, which is conducive to the subsequent air-jet crushing. A crushed material similar to primary particles is produced after the air-jet crushing, and the crushed material is then added to a reactor to further grow, such that primary particles in a shape of relatively compact and coarse blocky cubes are obtained. The high crystallinity degree further improves the tap density of the material, and the secondary growth of particle size further improves the cycling performance of a cathode material subsequently prepared by sintering the particles.

### BRIEF DESCRIPTION OF THE DRAWINGS

FIG. 1 is a scanning electron microscopy (SEM) image of Example 1 of the present disclosure.

### DETAILED DESCRIPTION

The present disclosure is further described below with reference to specific examples.

### Example 1

A preparation method for a ternary precursor with high tap density was provided, including the following steps:
(1) according to a molar ratio Ni:Co:Mn=6:2:2, nickel sulfate, cobalt sulfate, and manganese sulfate were adopted as raw materials to prepare a mixed salt solution in which a total concentration of metal ions of nickel, cobalt, and manganese was 1.5 mol/L;
(2) a sodium hydroxide solution with a concentration of 6.0 mol/L was prepared as a precipitating agent;
(3) aqueous ammonia with a concentration of 8.0 mol/L was prepared as a complexing agent;
(4) a sodium dodecyl benzene sulfonate (SDBS) surfactant aqueous solution with a concentration of 1 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 10.5 and an ammonia concentration of 6.0 g/L;
(6) a silica emulsion undergoing ultrasonic dispersion for 25 min was added to the base solution, where a resulting base solution had a silica mass concentration of 2% and a silica particle size of 1 nm to 100 nm;
(7) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 55° C., a pH of 10.5, and an ammonia concentration of 6 g/L, where a flow rate of the surfactant aqueous solution was controlled to be 50% of a flow rate of the mixed salt solution;
(8) when it was detected that D50 of a material in the reactor reached 2.0 μm, the feeding was stopped;
(9) the material in the reactor was separated by SLS to obtain a solid material, and the solid material was dried and then crushed with an air-jet crusher to obtain a crushed material with a particle size D50 of 320 nm;
(10) the crushed material was added to a reactor, a base solution was added until a bottom stirring paddle of the reactor was immersed, and stirring was started, where the base solution was a mixed solution of sodium hydroxide, aqueous ammonia, and a surfactant, and the base solution had a pH of 10.5, an ammonia concentration of 6.0 g/L, and a surfactant concentration of 2 mol/L;
(11) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 55° C., a pH of 10.5, and an ammonia concentration of 6.0 g/L, where a flow rate of the surfactant aqueous solution was controlled to be 50% of a flow rate of the mixed salt solution;
(12) when it was detected that D50 of a material in the reactor reached 10.5 μm, the feeding was stopped;
(13) the material in the reactor was separated by SLS to obtain a solid material; and
(14) the solid material was washed, dried, sieved, and demagnetized to obtain the ternary precursor with high tap density.

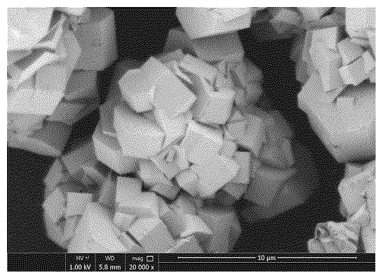

A ternary precursor with high tap density prepared by the above preparation method was provided. The ternary precursor with high tap density had a chemical formula of Ni_{0.6}Co_{0.2}Mn_{0.2}(OH)₂·xSiO₂, and was composed of secondary particles agglomerated by primary particles, where the primary particles were in a shape of blocky cubes and had a particle size of 0.1 μm to 5.0 μm, and the agglomerated secondary particles had a particle size of 10.5 μm. An SEM image of the ternary precursor with high tap density was shown in FIG. 1.

### Example 2

A preparation method for a ternary precursor with high tap density was provided, including the following steps:
(1) according to a molar ratio Ni:Co:Mn=8:1:1, nickel chloride, cobalt chloride, and manganese chloride were adopted as raw materials to prepare a mixed salt solution in which a total concentration of metal ions of nickel, cobalt, and manganese was 1.0 mol/L;
(2) a sodium hydroxide solution with a concentration of 4.0 mol/L was prepared as a precipitating agent;
(3) aqueous ammonia with a concentration of 6.0 mol/L was prepared as a complexing agent;
(4) a sodium dodecyl naphthalene sulfonate (SDNS) surfactant aqueous solution with a concentration of 0.1 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 10.0 and an ammonia concentration of 2.0 g/L;
(6) a silica emulsion undergoing ultrasonic dispersion for 20 min was added to the base solution, where a resulting base solution had a silica mass concentration of 1% and a silica particle size of 1 nm to 100 nm;
(7) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 45° C., a pH of 10.0, and an ammonia concentration of 2.0 g/L, where a flow rate of the surfactant aqueous solution was controlled to be 10% of a flow rate of the mixed salt solution;
(8) when it was detected that D50 of a material in the reactor reached 1.0 μm, the feeding was stopped;
(9) the material in the reactor was separated by SLS to obtain a solid material, and the solid material was dried and then crushed with an air-jet crusher to obtain a crushed material with a particle size D50 of 135 nm;
(10) the crushed material was added to a reactor, a base solution was added until a bottom stirring paddle of the reactor was immersed, and stirring was started, where the base solution was a mixed solution of sodium hydroxide, aqueous ammonia, and a surfactant, and the base solution had a pH of 10.0, an ammonia concentration of 2.0 g/L, and a surfactant concentration of 2 mol/L;
(11) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 45° C., a pH of 10.0, and an ammonia concentration of 2.0 g/L, where a flow rate of the surfactant aqueous solution was controlled to be 10% of a flow rate of the mixed salt solution;
(12) when it was detected that D50 of a material in the reactor reached 5.0 μm, the feeding was stopped;
(13) the material in the reactor was separated by SLS to obtain a solid material; and
(14) the solid material was washed, dried, sieved, and demagnetized to obtain the ternary precursor with high tap density.

A ternary precursor with high tap density prepared by the above preparation method was provided. The ternary precursor with high tap density had a chemical formula of Ni_{0.8}Co_{0.1}Mn_{0.1}(OH)₂·xSiO₂, and was composed of secondary particles agglomerated by primary particles, where the primary particles were in a shape of blocky cubes and had a particle size of 0.1 μm to 5.0 μm, and the agglomerated secondary particles had a particle size of 5.0 μm.

### Example 3

A preparation method for a ternary precursor with high tap density was provided, including the following steps:
(1) according to a molar ratio Ni:Co:Mn=5:2:3, nickel nitrate, cobalt nitrate, and manganese nitrate were adopted as raw materials to prepare a mixed salt solution in which a total concentration of metal ions of nickel, cobalt, and manganese was 2.5 mol/L;
(2) a sodium hydroxide solution with a concentration of 8.0 mol/L was prepared as a precipitating agent;
(3) aqueous ammonia with a concentration of 12.0 mol/L was prepared as a complexing agent;
(4) a sodium dodecyl sulfate (SDS) surfactant aqueous solution with a concentration of 2 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 11.0 and an ammonia concentration of 10.0 g/L;
(6) a silica emulsion undergoing ultrasonic dispersion for 30 min was added to the base solution, where a resulting base solution had a silica mass concentration of 3% and a silica particle size of 1 nm to 100 nm;
(7) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 65° C., a pH of 11.0, and an ammonia concentration of 10.0 g/L, where a flow rate of the surfactant aqueous solution was controlled to be 100% of a flow rate of the mixed salt solution;
(8) when it was detected that D50 of a material in the reactor reached 3.0 μm, the feeding was stopped;
(9) the material in the reactor was separated by SLS to obtain a solid material, and the solid material was dried and then crushed with an air-jet crusher to obtain a crushed material with a particle size D50 of 470 nm;
(10) the crushed material was added to a reactor, a base solution was added until a bottom stirring paddle of the reactor was immersed, and stirring was started, where the base solution was a mixed solution of sodium hydroxide, aqueous ammonia, and a surfactant, and the base solution had a pH of 11.0, an ammonia concentration of 10.0 g/L, and a surfactant concentration of 2 mol/L;
(11) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 65° C., a pH of 11.0, and an ammonia concentration of 10.0 g/L, where a flow rate of the surfactant aqueous solution was controlled to be 100% of a flow rate of the mixed salt solution;
(12) when it was detected that D50 of a material in the reactor reached 15.0 μm, the feeding was stopped;
(13) the material in the reactor was separated by SLS to obtain a solid material; and
(14) the solid material was washed, dried, sieved, and demagnetized to obtain the ternary precursor with high tap density.

A ternary precursor with high tap density prepared by the above preparation method was provided. The ternary precursor with high tap density had a chemical formula of Ni_{0.5}Co_{0.2}Mn_{0.3}(OH)₂·xSiO₂, and was composed of secondary particles agglomerated by primary particles, where the primary particles were in a shape of blocky cubes and had a particle size of 0.1 μm to 5.0 μm, and the agglomerated secondary particles had a particle size of 15.0 μm.

### Comparative Example 1

A preparation method for a ternary precursor was provided, including the following steps:
(1) according to a molar ratio Ni:Co:Mn=6:2:2, nickel sulfate, cobalt sulfate, and manganese sulfate were adopted as raw materials to prepare a mixed salt solution in which a total concentration of metal ions of nickel, cobalt, and manganese was 1.5 mol/L;
(2) a sodium hydroxide solution with a concentration of 6.0 mol/L was prepared as a precipitating agent;
(3) aqueous ammonia with a concentration of 8.0 mol/L was prepared as a complexing agent;
(4) an SDBS surfactant aqueous solution with a concentration of 1 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 10.5 and an ammonia concentration of 6.0 g/L;
(6) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 55° C., a pH of 10.5, and an ammonia concentration of 6 g/L, where a flow rate of the surfactant aqueous solution was controlled to be 50% of a flow rate of the mixed salt solution;
(7) when it was detected that D50 of a material in the reactor reached 10.5 μm, the feeding was stopped;
(8) the material in the reactor was separated by SLS to obtain a solid material; and
(9) the solid material was washed, dried, sieved, and demagnetized to obtain the target ternary precursor.

A ternary precursor prepared by the above preparation method was provided. The ternary precursor had a chemical formula of Ni_{0.6}Co_{0.2}Mn_{0.2}(OH)₂, and was composed of secondary particles agglomerated by primary particles, where the secondary particles had a particle size of 10.5 μm.

### Comparative Example 2

A preparation method for a ternary precursor with high tap density was provided, including the following steps:
(1) according to a molar ratio Ni:Co:Mn=8:1:1, nickel chloride, cobalt chloride, and manganese chloride were adopted as raw materials to prepare a mixed salt solution in which a total concentration of metal ions of nickel, cobalt, and manganese was 1.0 mol/L;
(2) a sodium hydroxide solution with a concentration of 4.0 mol/L was prepared as a precipitating agent;
(3) aqueous ammonia with a concentration of 6.0 mol/L was prepared as a complexing agent;
(4) an SDNS surfactant aqueous solution with a concentration of 0.1 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 10.0 and an ammonia concentration of 2.0 g/L;
(6) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 45° C., a pH of 10.0, and an ammonia concentration of 2.0 g/L, where a flow rate of the surfactant aqueous solution was controlled to be 10% of a flow rate of the mixed salt solution;
(7) when it was detected that D50 of a material in the reactor reached 5.0 μm, the feeding was stopped;
(8) the material in the reactor was separated by SLS to obtain a solid material; and
(9) the solid material was washed, dried, sieved, and demagnetized to obtain the target ternary precursor.

A ternary precursor prepared by the above preparation method was provided. The ternary precursor had a chemical formula of Ni_{0.8}Co_{0.1}Mn_{0.1}(OH)₂, and was composed of secondary particles agglomerated by primary particles, where the secondary particles had a particle size of 5.0 μm.

### Comparative Example 3

A preparation method for a ternary precursor was provided, including the following steps:
(1) according to a molar ratio Ni:Co:Mn=5:2:3, nickel nitrate, cobalt nitrate, and manganese nitrate were adopted as raw materials to prepare a mixed salt solution in which a total concentration of metal ions of nickel, cobalt, and manganese was 2.5 mol/L;
(2) a sodium hydroxide solution with a concentration of 8.0 mol/L was prepared as a precipitating agent;
(3) aqueous ammonia with a concentration of 12.0 mol/L was prepared as a complexing agent;
(4) an SDS surfactant aqueous solution with a concentration of 2 mol/L was prepared;
(5) a base solution was added to a reactor until a bottom stirring paddle was immersed, and stirring was started, where the base solution was a mixed solution of sodium hydroxide and aqueous ammonia, and the base solution had a pH of 11.0 and an ammonia concentration of 10.0 g/L;
(6) the mixed salt solution prepared in step (1), the sodium hydroxide solution prepared in step (2), the aqueous ammonia prepared in step (3), and the surfactant aqueous solution prepared in step (4) were concurrently fed into the reactor to allow a reaction at a temperature of 65° C., a pH of 11.0, and an ammonia concentration of 10.0 g/L, where a flow rate of the surfactant aqueous solution was controlled to be 100% of a flow rate of the mixed salt solution;
(7) when it was detected that D50 of a material in the reactor reached 15.0 μm, the feeding was stopped;
(8) the material in the reactor was separated by SLS to obtain a solid material; and
(9) the solid material was washed, dried, sieved, and demagnetized to obtain the target ternary precursor.

A ternary precursor prepared by the above preparation method was provided. The ternary precursor had a chemical formula of Ni_{0.5}Co_{0.2}Mn_{0.3}(OH)₂, and was composed of secondary particles agglomerated by primary particles, where the secondary particles had a particle size of 15.0 μm.

### Test Example

According to Chinese “GB/T 5162 Metallic powders—Determination of tap density”, a tap density of each of the ternary precursors of Examples 1 to 3 and Comparative Examples 1 to 3 was determined, and determination results were shown in Table 1.

TABLE 1
Tap density determination results of ternary precursors

| | Tap density (g/cm³) |
|---|---|
| Example 1 | 2.13 |
| Example 2 | 1.73 |
| Example 3 | 2.23 |
| Comparative Example 1 | 2.01 |
| Comparative Example 2 | 1.67 |
| Comparative Example 3 | 2.11 |

It can be seen from Table 1 that the ternary precursor prepared by the preparation method of the present disclosure has a tap density of 1.73 g/cm³ or higher, which can reach 2.23 g/cm³. In addition, it can be seen from the comparison between Example 1 and Comparative Example 1, the comparison between Example 2 and Comparative Example 2, and the comparison between Example 3 and Comparative Example 3 that, if the silica emulsion was not added during the preparation of the ternary precursor, the tap density of the finally-prepared ternary precursor decreased significantly.

The ternary precursors obtained in Example 1 and Comparative Example 1 were each thoroughly mixed with lithium carbonate according to a molar ratio of lithium to a total of nickel, cobalt, and manganese being 1.08:1, and a resulting mixture was then calcined at 850° C. for 12 h in an oxygen atmosphere to obtain a corresponding cathode material.

The ternary precursors obtained in Example 2 and Comparative Example 2 were each thoroughly mixed with lithium hydroxide according to a molar ratio of lithium to a total of nickel, cobalt, and manganese being 1.08:1, and a resulting mixture was then calcined at 800° C. for 12 h in an oxygen atmosphere to obtain a corresponding cathode material.

The ternary precursors obtained in Example 3 and Comparative Example 3 were each thoroughly mixed with lithium carbonate according to a molar ratio of lithium to a total of nickel, cobalt, and manganese being 1.08:1, and a resulting mixture was then calcined at 900° C. for 12 h in an oxygen atmosphere to obtain a corresponding cathode material.

The cathode material obtained above was used to assemble a button battery, and the battery was subjected to an electrochemical performance test. Specifically, with N-methylpyrrolidone (NMP) as a solvent, a cathode active material, acetylene black, and polyvinylidene fluoride (PVDF) were thoroughly mixed in a mass ratio of 8:1:1, coated on an aluminum foil, blow-dried at 80° C. for 8 h, and then vacuum-dried at 120° C. for 12 h; and a battery was assembled in an argon-protected glove box, with a lithium sheet as a negative electrode, a polypropylene (PP) membrane as a separator, and 1 M LiPF6-EC/DMC (1:1, v/v) as an electrolyte. The test was conducted at a current density of 1 C=160 mA/g and a charge/discharge cut-off voltage of 2.7 V to 4.3 V. Test results were shown in Table 2.

TABLE 2
Electrochemical performance test results of batteries

| | | Specific discharge | Cycling |
|---|---|---|---|
| | Discharge capacity | capacity after 100 | retention |
| | at 0.1 C, mAh/g | cycles, mAh/g | rate |
| Example 1 | 184 | 173 | 94.0% |
| Example 2 | 208 | 190 | 91.3% |
| Example 3 | 173 | 167 | 96.5% |
| Comparative | 178 | 159 | 89.3% |
| Example 1 | | | |
| Comparative | 202 | 178 | 88.1% |
| Example 2 | | | |
| Comparative | 164 | 153 | 93.3% |
| Example 3 | | | |

It can be seen from Table 2 that a battery assembled from a cathode material made from the ternary precursor prepared by the preparation method of the present disclosure has a discharge capacity of 173 mAh/g or higher at 0.1 C (which can reach 208 mAh/g at most), a specific discharge capacity of 167 mAh/g or higher after 100 cycles (which can reach 190 mAh/g at most), and a cycling retention rate of 91.3% or higher (which can reach 96.5% at most). In addition, it can be seen from the comparison between Example 1 and Comparative Example 1, the comparison between Example 2 and Comparative Example 2, and the comparison between Example 3 and Comparative Example 3 that, if the silica emulsion was not added during the preparation of the ternary precursor, the performance of the final battery will be degraded.

The above examples are preferred embodiments of the present disclosure. However, the embodiments of the present disclosure are not limited by the above examples. Any change, modification, substitution, combination, and simplification made without departing from the spiritual essence and principle of the present disclosure should be an equivalent replacement manner, and all are included in the protection scope of the present disclosure.

1. A preparation method for a ternary precursor with high tap density, comprising the following steps:
(1) adding a silica emulsion to an alkaline base solution under stirring to obtain a mixed liquid;
(2) adding a solution of mixed salts of metal ions of nickel, cobalt, and manganese, a precipitating agent, a complexing agent, and a surfactant to the mixed liquid in step (1) to allow a reaction until D50 of a material in the mixed liquid reaches 1.0 μm to 3.0 μm;
(3) separating the material in step (2) by solid-liquid separation to obtain a solid material, and drying and crushing the solid material to obtain a crushed material;
(4) mixing the crushed material obtained in step (3) with the alkaline base solution and the surfactant to obtain a mixture;
(5) adding the solution of mixed salts of metal ions of nickel, cobalt, and manganese, the precipitating agent, the complexing agent, and the surfactant to the mixture in step (4) to allow a reaction until D50 of a material in the mixture reaches 5.0 μm to 15.0 μm; and
(6) separating the material in step (5) by solid-liquid separation to obtain a solid material, and washing and drying the solid material to obtain the ternary precursor with high tap density;
wherein, the alkaline base solution is a mixed solution of sodium hydroxide and aqueous ammonia, and the alkaline base solution has a pH of 10.0 to 11.0 and an ammonia concentration of 2.0 g/L to 10.0 g/L;
in step (1), the mixed liquid has a silica mass concentration of 1% to 3% and a silica particle size of 1 nm to 100 nm;
in steps (2) and (5), the solution of mixed salts of metal ions of nickel, cobalt, and manganese, the precipitating agent, the complexing agent, and the surfactant are added concurrently, during which a pH of the mixed liquid in step (2) and the mixture in step (5) is controlled at 10.0 to 11.0, an ammonia concentration is controlled at 2.0 g/L to 10.0 g/L, and a flow rate of the surfactant is controlled to be 10% to 100% of a flow rate of the mixed salt solution;
the reactions in steps (2) and (5) are conducted at 45° C. to 65° C.; and
the ternary precursor with high tap density has a general chemical formula of Ni_{1-a-b}CoₐMn_{b}(OH)₂·xSiO₂, where 0<a<1 and 0<b<1, the ternary precursor with high tap density is composed of secondary particles agglomerated by primary particles, the primary particles are in a shape of blocky cubes and have a particle size of 0.1 μm to 5.0 μm, and the secondary particles obtained by agglomeration have a particle size of 5.0 μm to 15.0 μm.

2-3. (canceled)

4. The preparation method for the ternary precursor with high tap density according to claim 1, wherein a total concentration of metal ions of nickel, cobalt, and manganese in the solution of mixed salts of metal ions of nickel, cobalt, and manganese is 1.0 mol/L to 2.5 mol/L.

5. The preparation method for the ternary precursor with high tap density according to claim 1, wherein the precipitating agent is a sodium hydroxide solution with a concentration of 4.0 mol/L to 8.0 mol/L.

6. The preparation method for the ternary precursor with high tap density according to claim 1, wherein the complexing agent is aqueous ammonia with a concentration of 6.0 mol/L to 12.0 mol/L.

7. The preparation method for the ternary precursor with high tap density according to claim 1, wherein the surfactant is at least one of an alkylbenzene sulfonate aqueous solution, an alkylnaphthalene sulfonate aqueous solution, and an alkylsulfonate aqueous solution; and the surfactant has a concentration of 0.1 mol/L to 2 mol/L.

8. The preparation method for the ternary precursor with high tap density according to claim 1, wherein the crushed material obtained in step (3) has a particle size D50 of 100 nm to 500 nm.

9-10. (canceled)
